(19) United States
(12) Patent Application Publication
(10) Pub. No.: US 2015/0153902 A1
(43) Pub. Date: Jun. 4, 2015

(54) INFORMATION PROCESSING APPARATUS, CONTROL METHOD AND STORAGE MEDIUM

(71) Applicant: Kabushiki Kaisha Toshiba, Tokyo (JP)

(72) Inventors: Hiromichi Suzuki, Hamura Tokyo (JP); Nobutaka Nishigaki, Akishima Tokyo (JP)

(21) Appl. No.: 14/617,627

(22) Filed: Feb. 9, 2015

Related U.S. Application Data
(63) Continuation of application No. PCT/JP2013/057702, filed on Mar. 18, 2013.

(51) Int. Cl. G06F 3/041; G06F 3/042

(52) U.S. Cl. CPC G06F 3/0418; G06F 3/0425

(57) ABSTRACT

According to one embodiment, an information processing apparatus includes a display, a protective glass, a camera, a sensor and a correction module. The protective glass is configured to protect the display. The sensor is configured to detect a touch input on the protective glass and to output positional data. The correction module is configured to correct the touch input position indicated by the positional data obtained by the sensor, by using an image obtained by the camera.

### CROSS REFERENCE TO RELATED APPLICATIONS

This application is a Continuation Application of PCT Application No. PCT/JP2013/057702, filed Mar. 18, 2013, the entire contents of which are incorporated herein by reference.

### FIELD

Embodiments described herein relate generally to an information processing apparatus, a control method and a storage medium.

### BACKGROUND

In recent years, portable, battery-powered information processing apparatuses such as tablet computers and smartphones have become widely used. Such information processing apparatuses comprise, in most cases, touchscreen displays for easier input operation by users.

Users can instruct information processing apparatuses to execute functions related to icons or menus displayed on touchscreen displays by touching them with the finger.

Furthermore, the input operation using touchscreen displays is used not only for giving such operation instruction for the information processing apparatuses but also for handwriting input. When a touch input is performed on the touchscreen display, the locus is displayed on the touchscreen display.

On the touchscreen display, a transparent protective glass of a certain thickness is arranged to protect the display surface from an external force, and users in many cases see the touchscreen display from an oblique angle. Thus, the users often feel that the point of touch input is deviated from, for example, the point of locus displayed on the screen. There have been various proposals to prevent such apparent deviation.

In recent years, the information processing apparatuses with touchscreen displays comprise cameras to picture still and motion images. However, there has not been any finding that such cameras are applicable to solve the above-mentioned apparent deviation problem.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary top view showing a positional relationship between an information processing apparatus of first embodiment and a user.

FIG. 2 is an exemplary cross-sectional view showing a positional relationship between the information processing apparatus of the first embodiment and a user.

FIG. 3 is an exemplary view showing a system structure of the information processing apparatus of the first embodiment.

FIG. 4 is an exemplary view showing elements used for calculation of the degree of correction by a correction module of a touch input support application program operable in the information processing apparatus of the first embodiment.

FIG. 5 is an exemplary view showing a relationship between an image of a camera and an angle of the user's eyes in the information processing apparatus of the first embodiment.

FIG. 6 is an exemplary schematic view showing the elements used for calculation of the degree of correction by the correction module of the touch input support application program operable in the information processing apparatus of the first embodiment.

FIG. 7 is an exemplary flowchart showing a process procedure of the correction module of the touch input support application program operable on the information processing apparatus of the first embodiment.

FIG. 8 is an exemplary view showing a positional relationship between a camera and user's eyes in an information processing apparatus of second embodiment.

FIG. 9 is an exemplary view showing a relationship between a facial size captured by a camera and a distance between the camera and a user in the information processing apparatus of the second embodiment.

FIG. 10 is an exemplary top view showing a positional relationship between an information processing apparatus (with a plurality of cameras) of third embodiment and a user.

FIG. 11 is an exemplary schematic view showing a relationship between elements used for calculation of the degree of correction by the correction module of the touch input support application program operable in the information processing apparatus of the third embodiment.

### DETAILED DESCRIPTION

Various embodiments will be described hereinafter with reference to the accompanying drawings.

In general, according to one embodiment, an information processing apparatus comprises a display, a protective glass, a camera, a sensor and a correction module. The protective glass is configured to protect the display. The sensor is configured to detect a touch input on the protective glass and to output positional data. The correction module is configured to correct the touch input position indicated by the positional data obtained by the sensor, by using an image obtained by the camera.

### First Embodiment

First embodiment is explained.

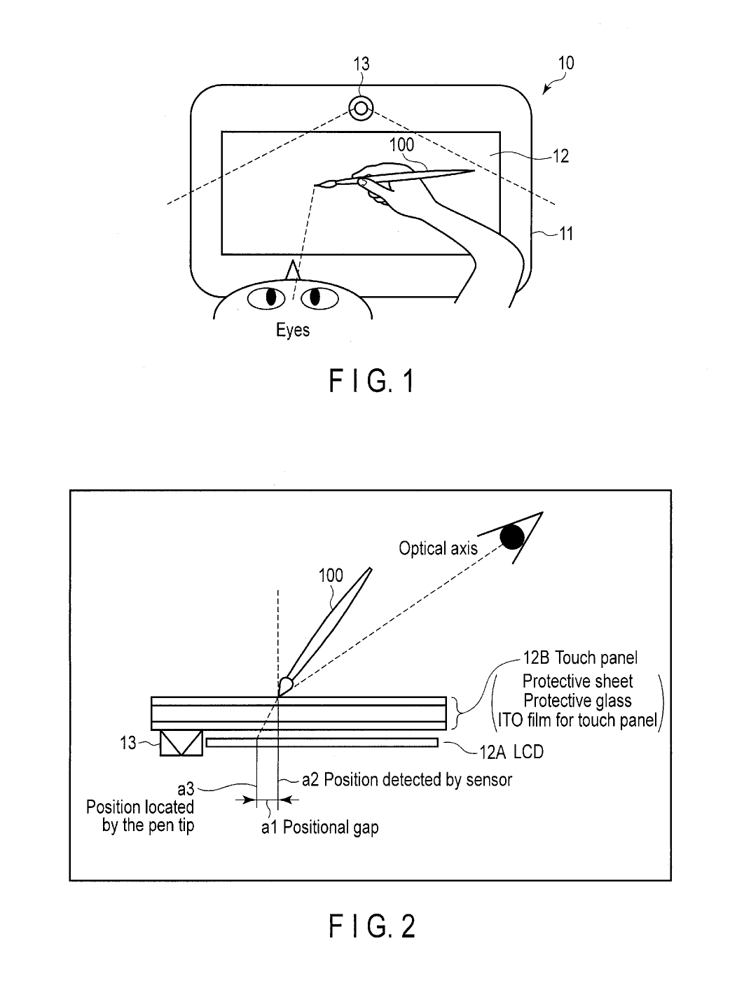

An information processing apparatus of the embodiment may be materialized as a touch-input operable mobile information processing apparatus such as a tablet terminal and a smartphone. FIG. 1 is an exemplary top view showing a positional relationship between the information processing apparatus and a user. FIG. 2 is an exemplary cross-sectional view showing a positional relationship between the information processing apparatus and a user.

As shown in FIG. 1, the information processing apparatus of the embodiment is here realized as a tablet terminal 10. The tablet terminal 10 comprises a body 11, touchscreen display 12, and camera 13. Both the touchscreen display 12 and the camera 13 are mounted on the upper part of the body 11.

The body 11 comprises a thin box-shaped casing. The touchscreen display 12 comprises a flat-panel display and a sensor configured to detect a touch input position on the touchscreen display 12. The flat-panel display is, for example, a liquid crystal display (LCD) 12A. The sensor is, for example, a capacitance type touch panel (digitizer) 12B. The touch panel 12B is provided to cover the screen of the flat-panel display.

Users use a pen (stylus) 100 to perform a touch input on the touchscreen display 12.

As shown in FIG. 2, a positional gap (a1) between a pen tip and a display position occurs since a position of the pen tip detected by the sensor (a2) is shifted from a position located by the pen tip (a3) due to refraction by a protective glass or an ITO film of the touch panel. The refraction should be considered because various devices are used from the surface of the touch panel 12B to the display surface of the LCD 12A and these devices have different refractive indices. Especially, when a certain gap is provided between the protective glass and the display device such as LCD 12A to avoid adhesion thereof by an external pressure from the display surface side, the refractive index of the device is greatly different from that of the air layer and the optical axis is shifted greatly. Thus, correction needs to be performed in consideration of the refractive index.

Thus, the tablet terminal 10 performs suitable correction using an image obtained by the camera 13. Now, details of this technique are explained.

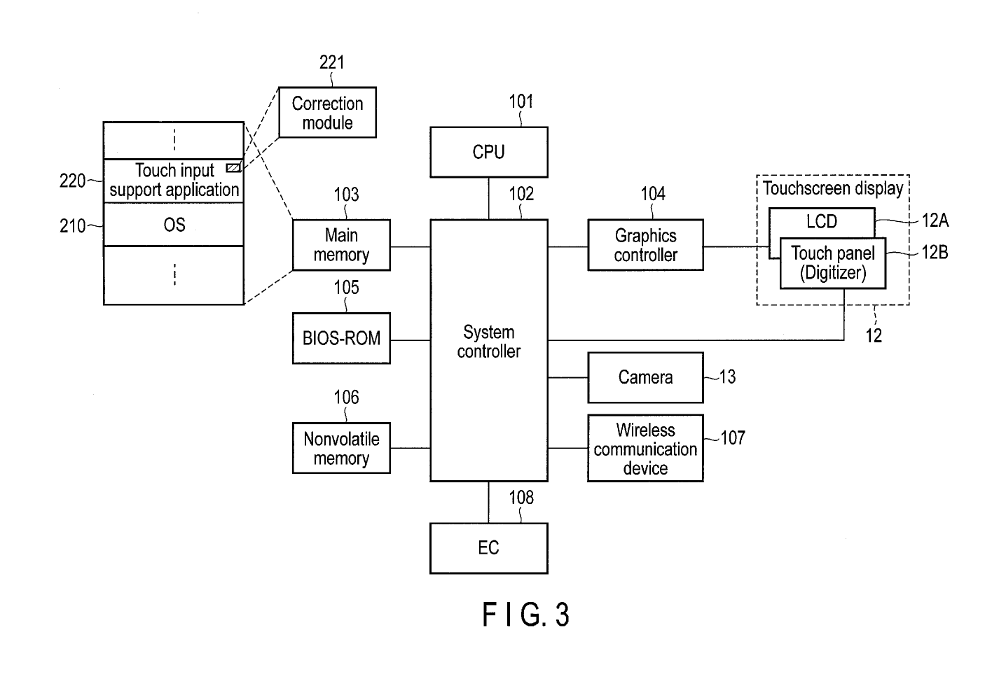

FIG. 3 is an exemplary view showing a system structure of the tablet terminal 10.

As shown in FIG. 3, the tablet terminal 10 comprises a CPU101, a system controller 102, a main memory 103, a graphics controller 104, a BIOS-ROM 105, a nonvolatile memory 106, a wireless communication device 107, an embedded controller (EC) 108, etc.

CPU 101 is a processor to control operations of various components in the tablet terminal 10. CPU 101 executes various softwares loaded from the nonvolatile memory 106 into the main memory 103. These softwares comprise an operating system (OS) 210 and a touch input support application program 220 operated under the control of the OS 210 (this program is described later). The touch input support application program 220 comprises a correction module 221.

Furthermore, CPU 101 executes basic input/output system (BIOS) stored in BIOS-ROM 105. BIOS is a program for hardware control.

System controller 102 is a device used for connection between the local bus of CPU 101 and various components. System controller 102 comprises a memory controller used for access control of the main memory 103. Furthermore, system controller 102 comprises a function to execute communication with the graphics controller 104 via a serial bus of PCI EXPRESS standard, for example.

The graphics controller 104 is a display controller to control the LCD 12A used as a display monitor of the tablet terminal 10. Display signals generated by the graphics controller 104 are sent to the LCD 12A. LCD 12A displays screen images based on the display signals. The touch panel 12B is disposed on the LCD 12A. The touch panel 12B is, for example, a capacitance type pointing device used for the touch input on the touchscreen display 12. The point at which the stylus 100 touches is detected by the touch panel 12B.

The wireless communication device 107 is a device configured to execute wireless communication such as wireless LAN or 3G mobile communication. EC 108 is a single-chip microcomputer comprising an embedded controller for power management. EC 108 comprises a function to turn on/off the tablet terminal 10 based on a power button operation by the user.

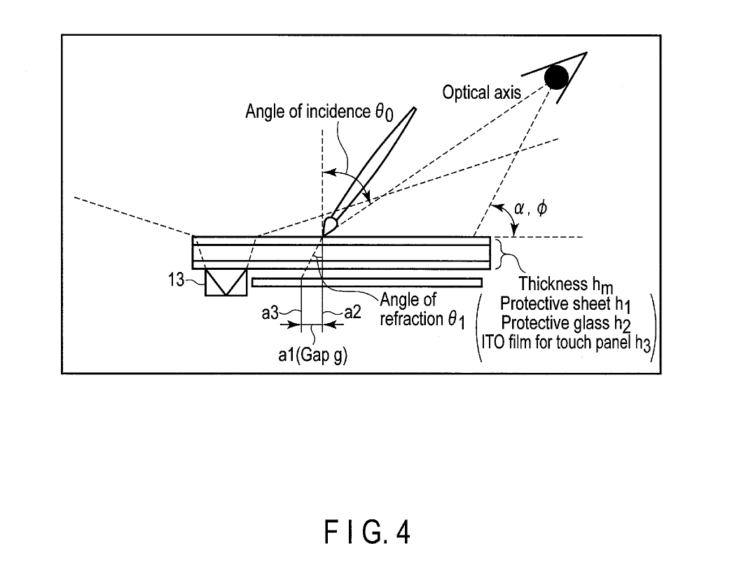

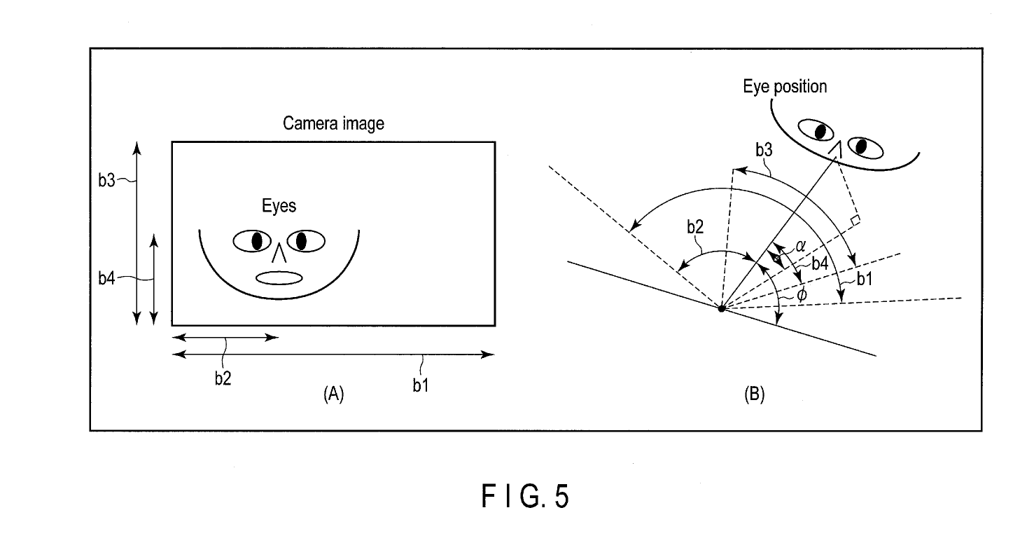

FIG. 4 shows elements used for calculation of the degree of correction by the correction module 221. Furthermore, FIG. 5 shows a relationship between an image of the camera 13 and an angle of user's eyes.

In FIG. 4 and FIG. 5, angle α is formed by the surface of the protective glass (the surface including the protective glass including the periphery of the body 11) and a line segment connecting the camera 13 with the eye. Furthermore, angle φ is formed by a first surface including the position of the camera 13 which is orthogonal to a photographing direction of the camera 13 and a second surface which is made by extending a center line vertically passing the position of the camera 13 on the first surface toward the eye. The correction module 221 (of the touch input support application program 220) calculates angles α and φ based on, for example, a correspondence table between coordinates of eyes, nose, and mouth captured in the camera image and angles in proportion to the eye positions with respect to effective viewing angle of the camera.

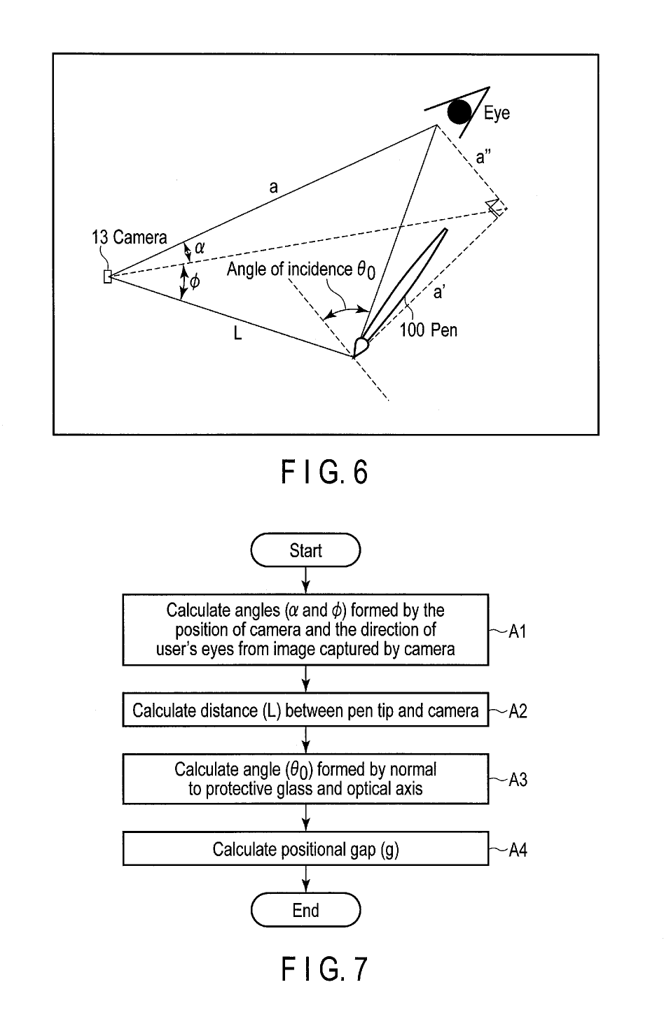

FIG. 6 is an exemplary schematic view showing the elements used for calculation of the degree of correction by the correction module 221.

The correction module 221 tracks the optical axis using the image captured by the camera 13 to calculate angles α and φ. Furthermore, the position of the camera is fixed, and thus, the correction module 221 detects the position of the touch input on the touchscreen display 12 to calculate a distance L between the camera 13 and the stylus 100. Furthermore, the distance between the camera 13 and the user's eyes can be estimated to be 20 to 50 cm, and thus, based on angles α and φ and distance L, the correction module 221 calculates distances a′ and a″ depicted in the figure using trigonometric function, and then calculates angle θ₀ formed by the normal to the protective glass and the optical axis.

Based on the above, the correction module 221 calculates the degree of correction using the following formula:

g=h₁×tan θ₁+ . . . +hₘ×tan θₘ

θₘ=arc sin(nₘ₋₁×sin θₘ₋₁/nₘ)

where g is the positional gap, hₘ (m=1, 2, . . . ) is the thickness of each device, nₘ (m=1, 2, . . . ) is the refractive index of each device, θₘ (m=1, 2, . . . ) is the angle of incidence with respect to each device of the optical axis, and θ₀ is derived from angles α and φ formed by the camera and the eye, distance a between the eye and the tablet body, and distance L between the pen tip and the camera.

Using the above degree of correction, the correction is performed to reduce the positional gap and users can perform stress-free writing.

The camera 13 may estimate the position of the eye from the positional relationship of nose, mouth, ears, eye blows, and hair. Furthermore, a range captured by the camera 13 is limited and if the recognition fails, a predetermined gap is used for the correction.

FIG. 7 is an exemplary flowchart showing a process procedure performed by the correction module 221.

The correction module 221 calculates the angles (α and φ) formed by the position of camera 13 and the direction of user's eyes from the image captured by the camera 13 (block A1). Further, the correction module 221 calculates the distance (L) between the pen tip and the camera (block A2). And then, the correction module 221 calculates an angle (θ) formed by the normal to the protective glass and the optical axis (block A3). Furthermore, the correction module 221 calculates a positional gap (g) (block A4).

As can be understood from the above, the tablet terminal 10 can correct the touch input position suitably using the image captured by the camera.

Furthermore, since the sensor is used as a digitizer (electromagnetic induction type) and the pen is used as a digitizer pen, the pen tip can be detected without being affected by a hand and the correction can be performed with higher accuracy.

### Second Embodiment

Now, second embodiment is explained.

In the embodiment, a distance between the camera 13 and the user's eyes is measured to improve the accuracy for positional gap correction.

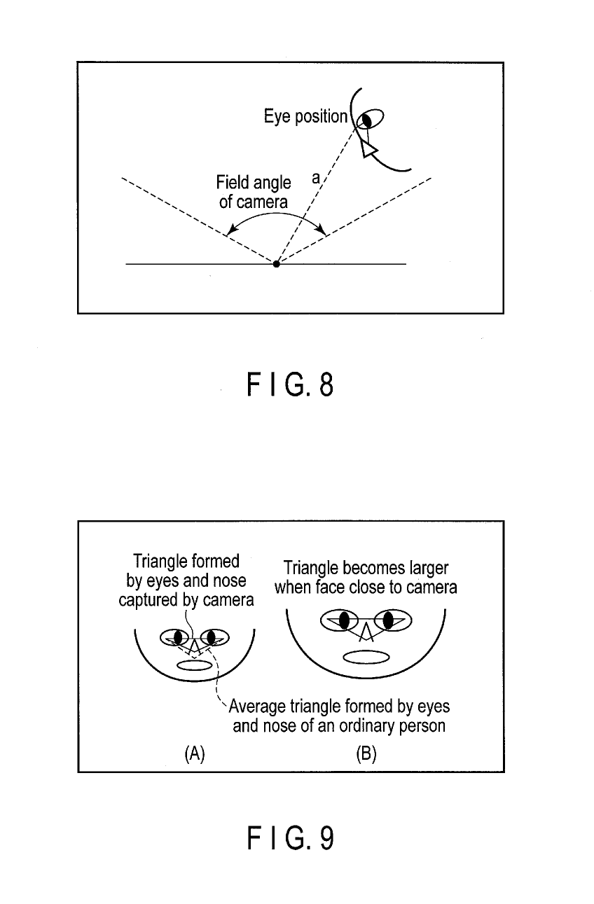

FIG. 8 is an exemplary view showing a positional relationship between the camera and the user's eyes. FIG. 9 is an exemplary view showing a relationship between a facial size captured by a camera and a distance between the camera and the user.

As can be understood from FIG. 8 and FIG. 9, a distance between the camera 13 and the eye of the user can be estimated from the image captured by the camera 13. Here, the correction module 221 stores, for example, a correspondence table between an average size of a triangle formed by eyes and nose of an ordinary person and a distance from the camera, detects the size of the triangle formed by the eyes and nose of the user from the screen, and refers to this correspondence table to acquire distance a.

Naturally, there are cases where the triangle of the eyes and nose cannot be captured by the camera, and only the eyes or nose and mouth are captured; however, such cases are used as reference values and a correspondence table between the eyes, nose, and mouth may be used to acquire distance a with a certain accuracy.

### Third Embodiment

Now, third embodiment is explained.

In the embodiment, a plurality of cameras are used for better accuracy in the correction of a positional.

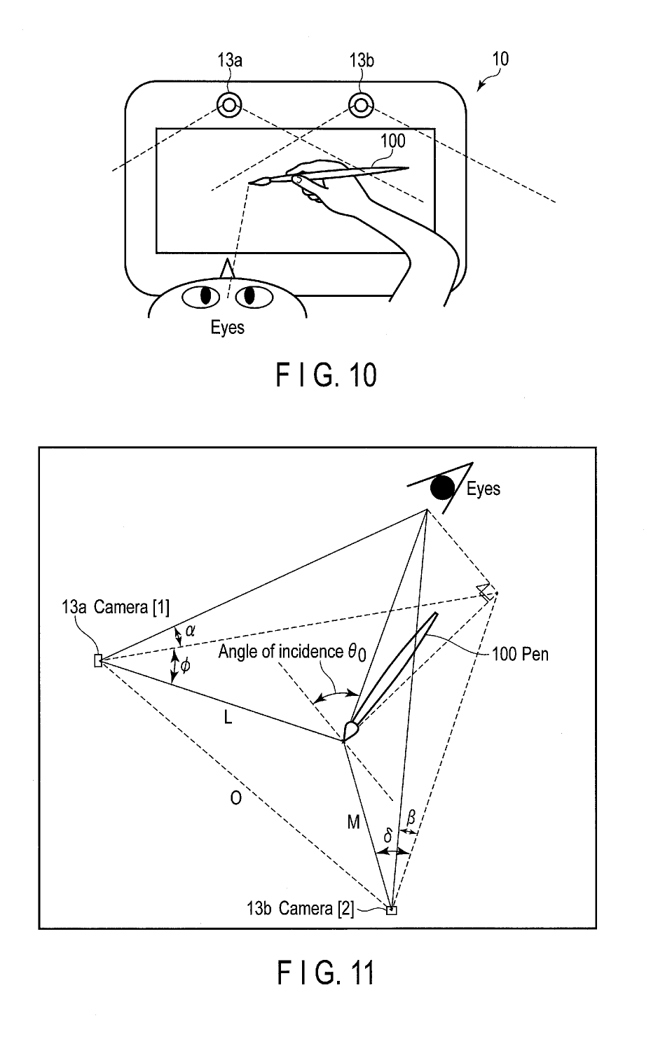

FIG. 10 is an exemplary top view showing a positional relationship between a tablet terminal 10 of the embodiment (with a plurality of cameras [13a and 13b]) and a user. Further, FIG. 11 schematically shows a relationship between elements used for calculation of the degree of correction by the correction module 221 of the embodiment.

In a tablet terminal, a plurality of cameras may be provided for viewing 3D images. Using the precedent procedure, the correction module 221 calculates angles α and φ formed by the position of the camera [1] and the direction of the user's eyes, distance L between the position of camera [1] and the pen position, angles β and δ formed by the position of camera [2] and the direction of the user's eyes, and distance M between camera [2] and the pen position. Distance O between camera [1] and camera [2] is known, the correction module 221 can eventually calculate angle θ₀ using trigonometric function.

Therefore, the correction of positional gap with high accuracy can be achieved.

As can be understood from the above, the tablet terminal 10 of each of the first to third embodiments can correct a touch input position suitably using the image captured by the camera.

Note that the operation procedure of the embodiments can all be achieved by software. By introducing the software in an ordinary computer via a computer readable, non-transitory storage medium, the advantage achieved by the embodiments can easily be achieved.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a display;
a protective glass configured to protect the display;
a camera;
a sensor configured to detect a touch input on the protective glass and to output positional data; and
a correction module configured to correct the touch input position indicated by the positional data obtained by the sensor, by using an image obtained by the camera.

2. The apparatus of claim 1, wherein the correction module is configured to detect an eye position of an object in a real space based on a position of the object in the image.

3. The apparatus of claim 2, wherein the correction module is configured to calculate a first angle and a second angle as data of the eye position of the object, the first angle formed by a surface of the protective glass and a line segment connecting the camera with an eye of the object, the second angle formed by a first surface including the position of the camera which is orthogonal to a photographing direction of the camera and a second surface which is made by extending a center line vertically passing the position of the camera on the first surface toward the eye of the object.

4. The processing apparatus of claim 3, the correction module is configured to calculate a third angle based on the first angle, the second angle, a distance between the camera and the touch input position, and a distance between the camera and the eye of the object, the third angle formed by a line segment of the normal to the protective glass surface passing through the touch input position and a line segment connecting the eye of the object and the touch input position.

5. The apparatus of claim 4, wherein the correction module is configured to calculate a distance between the camera and the eye of the object based on a size of parts in the image of the object in the image or a distance between the parts.

6. The apparatus of claim 4, wherein the correction module is configured to calculate a degree of correction of the touch input position based on the third angle and a distance between the protective glass surface and the display surface.

7. The apparatus of claim 6, wherein the correction module is configured to apply thickness and reflective index of each of one or more members interposed between the protective glass surface and the display surface to the calculation of the degree of correction.

8. The apparatus of claim 7, wherein the correction module is configured to calculate
g=h₁∴tan θ₁+ . . . +hₘ×tan θₘ
θₘ=arc sin(nₘ₋₁×sin θₘ₋₁/nₘ),
where g is the degree of correction, hₘ (m is an integer) is the thickness of each device, nₘ is the refractive index of each device, θₘ is the angle of incidence with respect to each device of the optical axis, an initial value (angle of incidence θ₀) of the optical axis is the third angle and is from the eye position of the object to the touch input position.

9. The apparatus of claim 1, wherein:
the camera comprises a first camera and a second camera; and
the correction module is configured to
calculates a first angle of the first camera and a second angle of the first camera based on a position of an object image in a first image captured by a first camera, the first angle of the first camera formed by a surface of the protective glass and a line segment connecting the first camera with an eye of the object, the second angle of the first camera formed by a first surface of the first camera including the position of the first camera which is orthogonal to a photographing direction of the first camera and a second surface of the first camera which is made by extending a center line vertically passing the position of the first camera on the first surface of the first camera toward the eye of the object, and
calculate a first angle of the second camera and a second angle of the second camera based on a position of an object image in a second image captured by a second camera, the first angle of the second camera formed by a surface of the protective glass and a line segment connecting the second camera with an eye of the object, the a second angle of the second camera formed by a first surface of the second camera including the position of the second camera which is orthogonal to a photographing direction of the second camera and a second surface of the second camera which is made by extending a center line vertically passing the position of the second camera on the first surface of the second camera toward the eye of the object, and
calculate a third angle based on the first angle and the second angle of the first camera, the first angle and the second angles of the second camera, a distance between the first camera and the touch input position, a distance between the second camera and the touch input position, and a distance between the first camera and the second camera, the third angle formed by a line segment of the normal to the protective glass surface passing through the touch input position and a line segment connecting the eye of the object and the touch input position.

10. The apparatus of claim 1, wherein the sensor comprises a digitizer and is configured to detect a touch input by a stylus on the protective glass.

11. A control method for an information processing apparatus, the method comprising:
detecting a touch input on a touchscreen display; and
correcting a position of the detected touch input by using an image obtained by a camera.

12. A computer-readable, non-transitory storage medium having stored thereon a computer program which is executable by a computer, the computer program controlling the computer to execute functions of:
detecting a touch input on a touchscreen display; and
correcting a position of the detected touch input by using an image obtained by a camera.
